(19) United States
(12) Patent Application Publication
(10) Pub. No.: US 2016/0343372 A1
(43) Pub. Date: Nov. 24, 2016

(54) INFORMATION PROCESSING DEVICE

(71) Applicant: SHARP KABUSHIKI KAISHA, Sakai--shi, Osaka (JP)

(72) Inventors: Akira MOTOMURA, Sakai-shi (JP); Masanori OGINO, Sakai-shi (JP)

(21) Appl. No.: 15/114,495

(22) PCT Filed: Jan. 22, 2015
(86) PCT No.: PCT/JP2015/051682

§ 371 Date: Jul. 27, 2016

(30) Foreign Application Priority Data
Feb. 18, 2014 (JP) 2014-028894

(51) Int. Cl. G10L 15/22; G10L 17/22

(52) U.S. Cl. CPC G10L 15/222; G10L 17/22; G10L 2015/225

(57) ABSTRACT

In order to provide a natural interaction with a speaker, an interactive robot (100) of the present invention includes: a storage section (12); an input management section (21) that accepts an input voice by storing the input voice in the storage section (12) in association with attribute information; a phrase output section (23) that causes a phrase corresponding to the voice to be presented; and an output necessity determination section (22) that determines, in a case where a second voice is inputted before a first phrase corresponding to a first voice is presented, in accordance with at least one piece of attribute information, whether or not the first phrase needs to be presented.

### TECHNICAL FIELD

The present invention relates to an information processing device and the like that presents a given phrase to a speaker in response to a voice uttered by the speaker.

### BACKGROUND ART

Interactive systems that enable an interaction between a human and a robot have been widely studied. For example, Patent Literature 1 discloses an interactive information system that is capable of continuing and developing an interaction with a speaker by using databases of news and conversations. Patent Literature 2 discloses an interaction method and an interactive device each for maintaining, in a multi-interactive system that handles a plurality of interaction scenarios, continuity of a response pattern while interaction scenarios are being switched, so as to prevent confusion of a speaker. Patent Literature 3 discloses a voice interactive device that reorders inputted voices while performing a recognition process, so as to provide a speaker with a stress-free and awkwardness-free voice interaction.

### CITATION LIST

### Patent Literature

[Patent Literature 1]

Japanese Patent Application Publication Tokukai No. 2006-171719 (Publication date: Jun. 29, 2006)

### [Patent Literature 2]

Japanese Patent Application Publication Tokukai No. 2007-79397 (Publication date: Mar. 29, 2007)

### [Patent Literature 3]

Japanese Patent Application Publication Tokukaihei No. 10-124087 (Publication date: May 15, 1998)

### [Patent Literature 4]

Japanese Patent Application Publication Tokukai No. 2006-106761 (Publication date: Apr. 20, 2006)

### SUMMARY OF INVENTION

### Technical Problem

Conventional techniques, such as those disclosed in Patent Literatures 1 through 4, are designed to provide a simple question-and-response service realized by communication on a one-response-to-one-question basis. In such a question-and-response service, it is assumed that a speaker would wait for a robot to finish responding to his/her question. This hinders realization of a natural interaction similar to interactions between humans.

Specifically, interactive systems have the following problem as with the case of interactions between humans. That is, it is assumed that a response (phrase) to an earlier query (voice) which a speaker asked a robot is delayed and that another query is inputted before the response to the earlier query is outputted. In such a case, output of the response to the earlier query will be interrupted by output of a response to the another query. In order to achieve a natural (human-like) interaction, such an interruption in response output needs to be appropriately processed depending on a situation of an interaction. However, none of the conventional techniques meets such a demand because they are designed to provide communication on the one-response-to-one-question basis.

The present invention has been made in view of the above problem, and an object of the present invention is (i) to provide an information processing device and an interactive system each of which is capable of realizing a natural interaction with a speaker, even in a case where a plurality of voices are successively inputted and (ii) to provide a program for controlling such an information processing device.

### Solution to Problem

In order to attain the above object, an information processing device of an aspect of the present invention is an information processing device that presents a given phrase to a user in response to a voice uttered by the user, the given phrase including a first phrase and a second phrase, the voice including a first voice and a second voice, the first voice being one that was inputted earlier than the second voice, the information processing device including: a storage section; an accepting section that accepts the voice which was inputted, by storing, in the storage section, the voice or a recognition result of the voice in association with attribute information indicative of an attribute of the voice; a presentation section that presents the given phrase corresponding to the voice accepted by the accepting section; and a determination section that, in a case where the second voice is inputted before the presentation section presents the first phrase corresponding to the first voice, determines, in accordance with at least one piece of attribute information stored in the storage section, whether or not the first phrase needs to be presented.

### Advantageous Effects of Invention

According to an aspect of the present invention, it is possible to realize a natural interaction with a speaker even in a case where a plurality of voices are successively inputted.

### BRIEF DESCRIPTION OF DRAWINGS

FIG. 1 is a view illustrating a configuration of a main part of each of an interactive robot and a server of Embodiments 1 through 5 of the present invention.

FIG. 2 is a view schematically illustrating an interactive system of Embodiments 1 through 5 of the present invention.

FIG. 3 is a set of views (a) through (c), (a) of FIG. 3 illustrating a concrete example of a voice management table of Embodiment 1, (b) of FIG. 3 illustrating a concrete example of a threshold of Embodiment 1, and (c) of FIG. 3 illustrating another concrete example of the voice management table.

FIG. 4 is a flowchart illustrating a process performed by the interactive system of Embodiment 1.

FIG. 5 is a set of views (a) through (d), (a) through (c) of FIG. 5 each illustrating a concrete example of a voice management table of Embodiment 2, and (d) of FIG. 5 illustrating a concrete example a threshold of Embodiment 2.

FIG. 6 is a set of views (a) through (c) each illustrating a concrete example of the voice management table.

FIG. 7 is a flowchart illustrating a process performed by the interactive system of Embodiment 2.

FIG. 8 is a pair of views (a) and (b), (a) of FIG. 8 illustrating a concrete example of a voice management table of Embodiment 3, and (b) of FIG. 8 illustrating a concrete example of a speaker DB of Embodiment 3.

FIG. 9 is a flowchart illustrating a process performed by the interactive system of Embodiment 3.

FIG. 10 is a set of views (a) through (c), (a) of FIG. 10 illustrating another concrete example of a voice management table of Embodiment 4, (b) of FIG. 10 illustrating a concrete example of a threshold of Embodiment 4, and (c) of FIG. 10 illustrating a concrete example of a speaker DB of Embodiment 4.

FIG. 11 is a flowchart illustrating a process performed by the interactive system of Embodiment 4.

FIG. 12 is a view illustrating another example of a configuration of a main part of each of the interactive robot and the server of Embodiment 4.

### DESCRIPTION OF EMBODIMENTS

### Embodiment 1

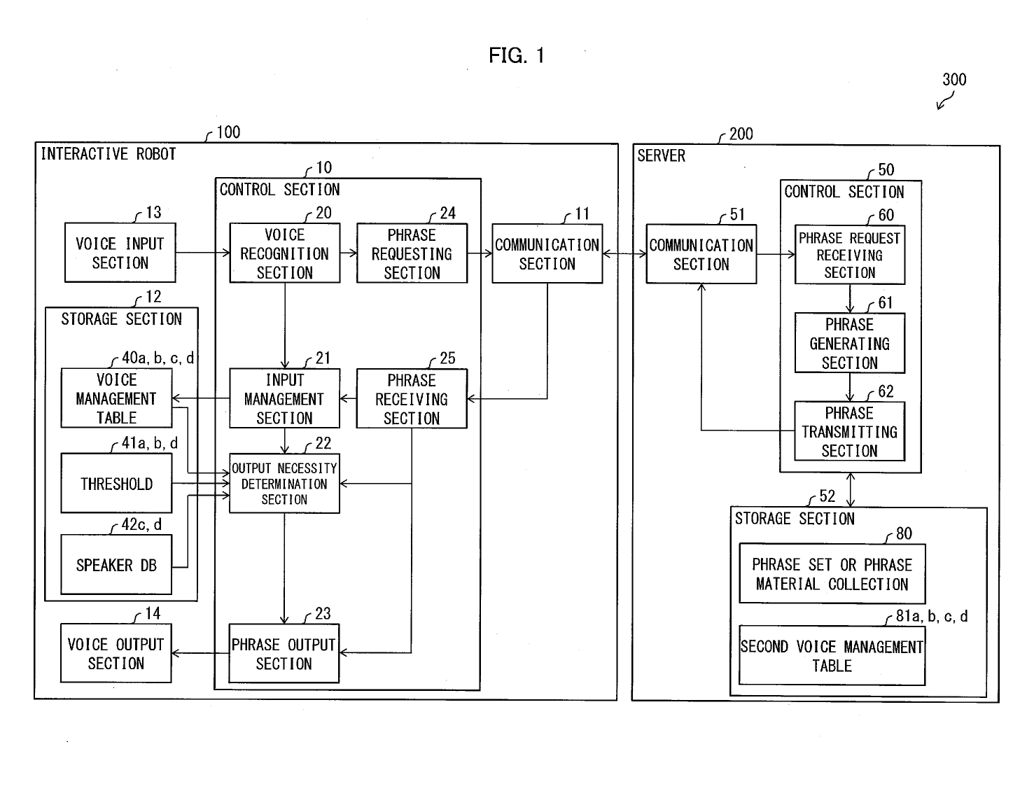

The following description will discuss Embodiment 1 of the present invention with reference to FIGS. 1 through 4.

[Outline of Interactive System]

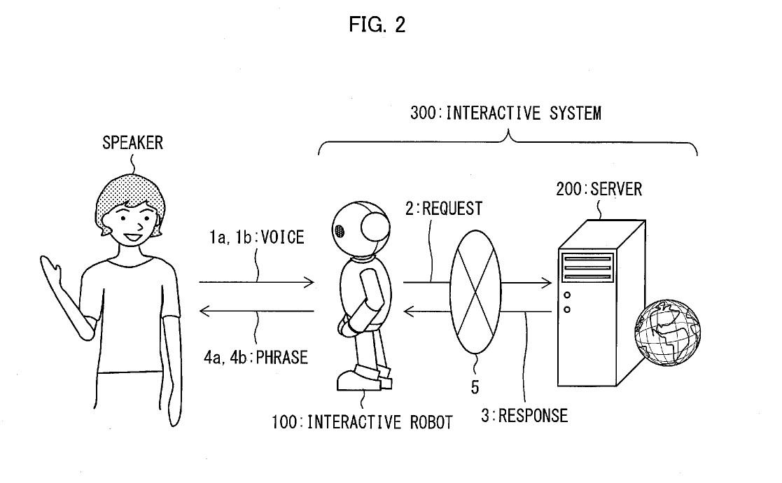

FIG. 2 is a view schematically illustrating an interactive system 300. As illustrated in FIG. 2, the interactive system (information processing system) 300 includes an interactive robot (information processing device) 100 and a server (external device) 200. According to the interactive system 300, a speaker inputs a voice (e.g., a voice 1a, 1b, . . . ) in natural language into the interactive robot 100, and listens to (or reads) a phrase (e.g., a phrase 4a, 4b, . . . ) that the interactive robot 100 presents as a response to the voice thus inputted. The speaker is thus capable of naturally interacting with the interactive robot 100, thereby obtaining various types of information. Specifically, the interactive robot 100 is a device that presents a given phrase (response) to a speaker in response to a voice uttered by the speaker. An information processing device, of the present invention, that functions as the interactive robot 100 is not limited to an interactive robot, provided that the information processing device is capable of (i) accepting an inputted voice and (ii) presenting a given phrase in accordance with the inputted voice. The interactive robot 100 can be realized by way of, for example, a tablet terminal, a smartphone, or a personal computer.

The server 200 is a device that supplies, in response to a voice that a speaker uttered to the interactive robot 100, a given phrase to the interactive robot 100 so that the interactive robot 100 presents the given phrase to the speaker. Note that, as illustrated in FIG. 2, the interactive robot 100 and the server 200 are communicably connected to each other via a communication network 5 that follows a given communication method.

According to Embodiment 1, for example, the interactive robot 100 has a function of recognizing an inputted voice. The interactive robot 100 requests, from the server 200, a phrase corresponding to an inputted voice, by transmitting, to the server 200, a voice recognition result (i.e., a result of recognizing the inputted voice) as a request 2. Based on the voice recognition result transmitted from the interactive robot 100, the server 200 generates the phrase corresponding to the inputted voice, and transmits the phrase thus generated to the interactive robot 100 as a response 3. Note that a method of generating a phrase is not limited to a particular method, and can be achieved by a conventional technique. For example, the server 200 can generate a phrase corresponding to a voice, by obtaining an appropriate phrase from a set of phrases (i.e., a phrase set) which are stored in a storage section in association with respective voice recognition results. Alternatively, the server 200 can generate a phrase corresponding to a voice by appropriately combining, from a collection of phrase materials (i.e., a phrase material collection) stored in a storage section, phrase materials that match a voice recognition result.

By taking, as a concrete example, the interactive system 300 in which the interactive robot 100 performs voice recognition, functions of the information processing device of the present invention will be described below. Note, however, that the concrete example is a mere example for description, and does not limit a configuration of the information processing device of the present invention.

[Configuration of Interactive Robot]

FIG. 1 is a view illustrating a configuration of a main part of each of the interactive robot 100 and the server 200. The interactive robot 100 includes a control section 10, a communication section 11, a storage section 12, a voice input section 13, and a voice output section 14.

The communication section 11 communicates with an external device (e.g., the server 200) via the communication network 5 that follows the given communication method. The communication section 11 is not limited in terms of a communication line, a communication method, a communication medium, or the like, provided that the communication section 11 has a fundamental function which realizes communication with the external device. The communication section 11 can be constituted by, for example, a device such as an Ethernet (registered trademark) adopter. Further, the communication section 11 can employ a communication method, such as IEEE802.11 wireless communication and Bluetooth (registered trademark), and/or a communication medium employing such a communication method. According to Embodiment 1, the communication section 11 includes at least (i) a transmitting section that transmits a request 2 to the server 200 and (ii) a receiving section that receives a response 3 from the server 200.

The voice input section 13 is constituted by a microphone to which voices (e.g., voices 1a, 1b, . . . of a speaker) are collected from a vicinity of the interactive robot 100. Each of the voices collected from the voice input section 13 is converted into a digital signal, and supplied to a voice recognition section 20. The voice output section 14 is constituted by a speaker device which converts, into a sound, a phrase (e.g., phrase 4a, 4b, . . . ) processed by each section of the control section 10 and outputted from the control section 10, and from which the sound is outputted. Each of the voice input section 13 and the voice output section 14 can be embedded in the interactive robot 100. Alternatively, each of the voice input section 13 and the voice output section 14 can be externally connected to the interactive robot 100 via an external connection terminal or can be communicably connected to the interactive robot 100.

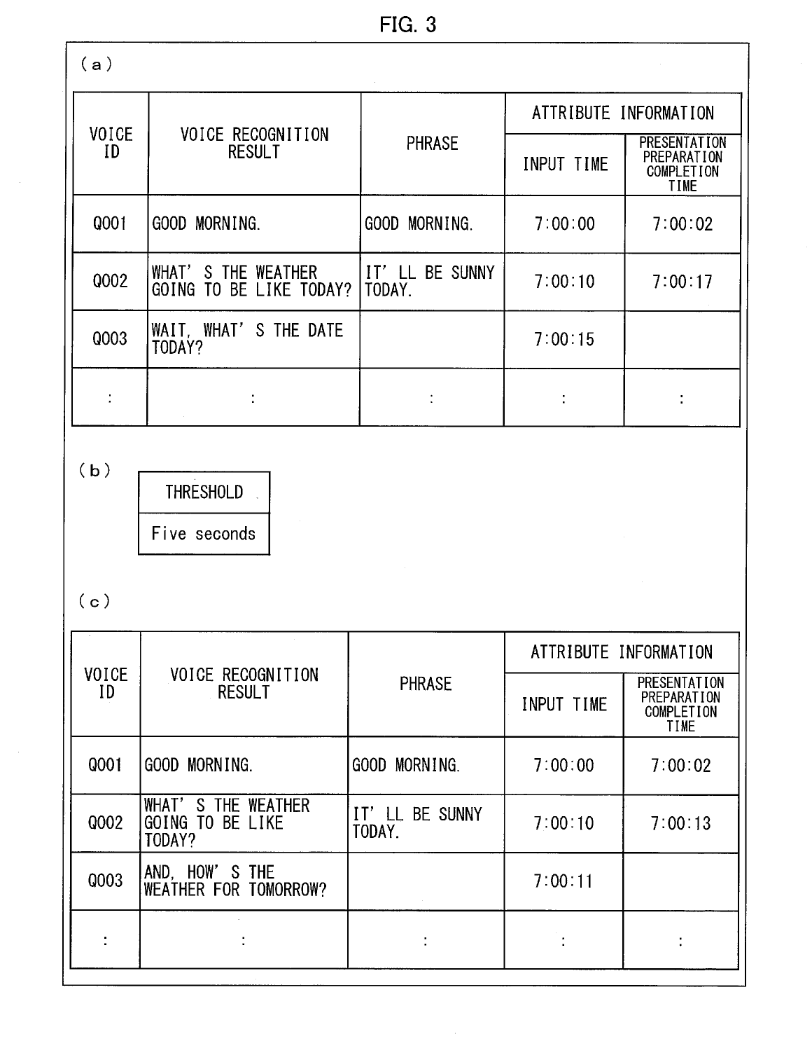

The storage section 12 is constituted by a non-volatile storage device such as a read only memory (ROM), a non-volatile random access memory (NVRAM), and a flash memory. According to Embodiment 1, a voice management table 40a and a threshold 41a (see, for example, FIG. 3) are stored in the storage section 12.

The control section 10 controls various functions of the interactive robot 100 in an integrated manner. The control section 10 includes, as its functional blocks, at least an input management section 21, an output necessity determination section 22, and a phrase output section 23. The control section 10 further includes, as necessary, the voice recognition section 20, a phrase requesting section 24, and a phrase receiving section 25. Such functional blocks can be realized by, for example, a central processing unit (CPU) reading out a program stored in a non-volatile storage medium (storage section 12) to a random access memory (RAM) (not illustrated) or the like and executing the program.

The voice recognition section 20 analyzes a digital signal into which a voice inputted via the voice input section 13 is converted, and converts a word of the voice into text data. This text data is processed, as a voice recognition result, by each section of the interactive robot 100 or the server 200 which each section is downstream from the voice recognition section 20. Note that the voice recognition section 20 only needs to employ a known voice recognition technique as appropriate.

The input management section (accepting section) 21 manages (i) voices inputted by a speaker and (ii) an input history of the voices. Specifically, the input management section 21 associates, in regard to a voice which was inputted, (i) information (for example, a voice ID, a voice recognition result, or a digital signal into which the voice is converted (hereinafter, collectively referred to as voice data)) that uniquely identifies the voice with (ii) at least one piece of attribute information (later described in FIG. 3) that indicates an attribute of the voice, and stores the information and the at least one piece of attribute information in the voice management table 40a.

The output necessity determination section (determination section) 22 determines whether or not to cause the phrase output section 23 (later described) to output a response (hereinafter, referred to as a “phrase”) to a voice which was inputted. Specifically, in a case where a plurality of voices are successively inputted, the output necessity determination section 22 determines whether or not a phrase needs to be outputted, in accordance with attribute information that is given to a corresponding one of the plurality of voices by the input management section 21. This makes it possible to omit output of an unnecessary phrase and thereby maintains a natural flow of, not communication on the one-response-to-one-question basis, but an interaction in which a speaker successively inputs a plurality of voices into the interactive robot 100 without waiting for each of responses to the respective plurality of voices.

In accordance with a determination made by the output necessity determination section 22, the phrase output section (presentation section) 23 causes a phrase corresponding to a voice inputted by a speaker to be presented in such a format that the phrase can be recognized by the speaker. Note that the phrase output section 23 does not cause a phrase to be presented, in a case where the output necessity determination section 22 determines that the phrase does not need to be outputted. The phrase output section 23 causes a phrase to be presented, by, for example, (i) converting the phrase, in a text format, into voice data and (ii) causing a sound based on the voice data to be outputted from the voice output section 14 so that a speaker recognizes the phrase by the sound. Note, however, that a method of causing a phrase to be presented is not limited to such a method. Alternatively, the phrase output section 23 can cause a phrase to be presented, by supplying the phrase, in the text format, to a display section (not illustrated) so that a speaker visually recognizes the phrase by a character.

The phrase requesting section 24 (requesting section) requests, from the server 200, a phrase corresponding to a voice inputted into the interactive robot 100. For example, the phrase requesting section 24 transmits a request 2, containing a voice recognition result, to the server 200 via the communication section 11.

The phrase receiving section 25 (receiving section) receives a phrase supplied from the server 200. Specifically, the phrase receiving section 25 receives a response 3 that the server 200 transmitted in response to the request 2. The phrase receiving section 25 analyzes contents of the response 3, notifies the output necessity determination section 22 of which voice a phrase that the phrase receiving section 25 has received corresponds to, and supplies the phrase thus received to the phrase output section 23.

[Configuration of Server]

The server 200 includes a control section 50, a communication section 51, and a storage section 52 (see FIG. 1). The communication section 51 is configured in a manner basically similar to that of the communication section 11, and communicates with the interactive robot 100. The communication section 51 includes at least (i) a receiving section that receives a request 2 from the interactive robot 100 and (ii) a transmitting section that transmits a response 3 to the interactive robot 100. The storage section 52 is configured in a manner basically similar to that of the storage section 12. In the storage section 52, various types of information (e.g., a phrase set or phrase material collection 80) to be processed by the server 200 are stored.

The control section 50 controls various functions of the server 200 in an integrated manner. The control section 50 includes, as its functional blocks, a phrase request receiving section 60, a phrase generating section 61, and a phrase transmitting section 62. Such functional blocks can be realized by, for example, a CPU reading out a program stored in a non-volatile storage medium (storage section 52) to a RAM (not illustrated) or the like, and executing the program. The phrase request receiving section 60 (accepting section) receives, from the interactive robot 100, a request 2 requesting a phrase. The phrase generating section (generating section) 61 generates, based on a voice recognition result contained in the request 2 thus received, a phrase corresponding to a voice indicated by the voice recognition result. Specifically, the phrase generating section 61 generates the phrase in the text format by obtaining, from the phrase set or phrase material collection 80, the phrase associated with the voice recognition result or a phrase material. The phrase transmitting section (transmitting section) 62 transmits, to the interactive robot 100, a response 3 containing the phrase thus generated, as a response to the request 2.

[Regarding Information]

(a) of FIG. 3 is a view illustrating a concrete example of the voice management table 40a, of Embodiment 1, stored in the storage section 12. (b) of FIG. 3 is a view illustrating a concrete example of the threshold 41a, of Embodiment 1, stored in the storage section 12. (c) of FIG. 3 is a view illustrating another concrete example of the voice management table 40a. Note that FIG. 3 illustrates, for ease of understanding, a concrete example of information to be processed by the interactive system 300, and does not limit a configuration of each device of the interactive system 300. Note also that FIG. 3 illustrates a data structure of information in a table format as a mere example, and does not intend to limit the data structure to the table format. The same applies to other drawings that illustrate data structures.

With reference to (a) of FIG. 3, the voice management table 40a retained by the interactive robot 100 of Embodiment 1 will be described below. The voice management table 40a has a structure such that, for an inputted voice, at least (i) a voice ID that identifies the inputted voice and (ii) attribute information are stored therein in association with each other. Note that, as illustrated in (a) of FIG. 3, the voice management table 40a can further store therein (i) a voice recognition result of the inputted voice and (ii) a phrase corresponding to the inputted voice. Note also that, though not illustrated in FIG. 3, the voice management table 40a can further store therein voice data of the inputted voice, in addition to or instead of the voice ID, the voice recognition result, and the phrase. The voice recognition result is generated by the voice recognition section 20, and is used by the phrase requesting section 24 to generate a request 2. The phrase is received by the phrase receiving section 25, and is processed by the phrase output section 23.

In Embodiment 1, the attribute information includes an input time and a presentation preparation completion time. The input time indicates a time at which a voice was inputted. For example, the input management section 21 obtains, as the input time, a time at which the voice, uttered by a user, was inputted to the voice input section 13. Alternatively, the input management section 21 can obtain, as the input time, a time at which the voice recognition section 20 stored the voice recognition result in the voice management table 40a. The presentation preparation completion time indicates a time at which the phrase corresponding to the inputted voice was obtained by the interactive robot 100 and was made ready for output. For example, the input management section 21 obtains, as the presentation preparation completion time, a time at which the phrase receiving section 25 received the phrase from the server 200.

For the inputted voice, a time (required time) required between (i) when the voice was inputted and (ii) when the phrase corresponding to the voice was made ready for output is calculated based on the input time and the presentation preparation completion time. Note that the required time can also be stored, as part of the attribute information, in the voice management table 40a by the input management section 21. Alternatively, the required time can be calculated by the output necessity determination section 22, as necessary, in accordance with the input time and the presentation preparation completion time. The output necessity determination section 22 uses the required time to determine whether or not the phrase needs to be outputted.

In a case where the interactive robot 100 takes time to respond to a query of a user and pauses an interaction, the user may successively input a voice about another topic. Such a case will be described below in detail with reference to (a) of FIG. 3. It is assumed that a second voice Q003 is inputted before the phrase output section 23 outputs a first phrase “It'll be sunny today.” corresponding to a first voice Q002 which has been inputted earlier than the second voice Q003. In this case, the output necessity determination section 22 determines whether or not the first phrase needs to be outputted, in accordance with a required time of the first voice. More specifically, the threshold 41a (in the example illustrated in (b) of FIG. 3, 5 seconds) is stored in the storage section 12. The output necessity determination section 22 calculates that the required time of the first voice is 7 seconds, by subtracting an input time (7:00:10) from a presentation preparation completion time (7:00:17), and compares the required time of the first voice with the threshold 41a (5 seconds). In a case where the required time exceeds the threshold 41a, the output necessity determination section 22 determines that the first phrase does not need to be outputted. That is, in the above case, the output necessity determination section 22 determines that the first phrase, corresponding to the first voice Q002, does not need to be outputted. Accordingly, the phrase output section 23 cancels outputting the first phrase “It'll be sunny today.” It is thus possible to avoid outputting an unnatural response “It'll be sunny today.” after (i) a long time (7 seconds) has elapsed since the first voice “What's the weather going to be like today?” was inputted and (ii) the second voice “Wait, what's the date today?” about another topic is inputted. Note that, in a case where the first phrase is omitted, the interactive robot 100 continues an interaction with a user by outputting a second phrase, for example, “Today is the fifteenth of this month.” in response to the second voice, unless another voice is successively inputted after the second voice.

Meanwhile, a user may successively input two voices about an identical topic at a very short interval. Another example will be described below in detail with reference to (c) of FIG. 3. It is assumed that a second voice Q003 is inputted before the phrase output section 23 outputs a first phrase corresponding to a first voice Q002 which has been inputted earlier than the second voice Q003. In this case, the output necessity determination section 22 determines whether or not the first phrase needs to be outputted, in accordance with a required time of the first voice. According to the concrete example illustrated in (c) of FIG. 3, the required time of the first voice is 3 seconds, which does not exceed the threshold 41a (5 seconds). The output necessity determination section 22 therefore determines that the first phrase needs to be outputted. Accordingly, the phrase output section 23 outputs the first phrase “It'll be sunny today.” even after the second voice “How's the weather for tomorrow?” is inputted. In this case, not very long time (only 3 seconds) has elapsed since the first voice “What's the weather going to be like today?” was inputted, and the second voice, which was successively inputted at a short interval after the first voice, is also about an identical weather-related topic. In view of this, it is not unnatural that the first phrase be outputted after second voice is inputted. Note that, after the first phrase is outputted, the interactive robot 100 continues an interaction with a user by outputting a second phrase, for example, “Tomorrow will be a cloudy day.” in response to the second voice, unless another voice is successively inputted after the second voice.

[Process Flow]

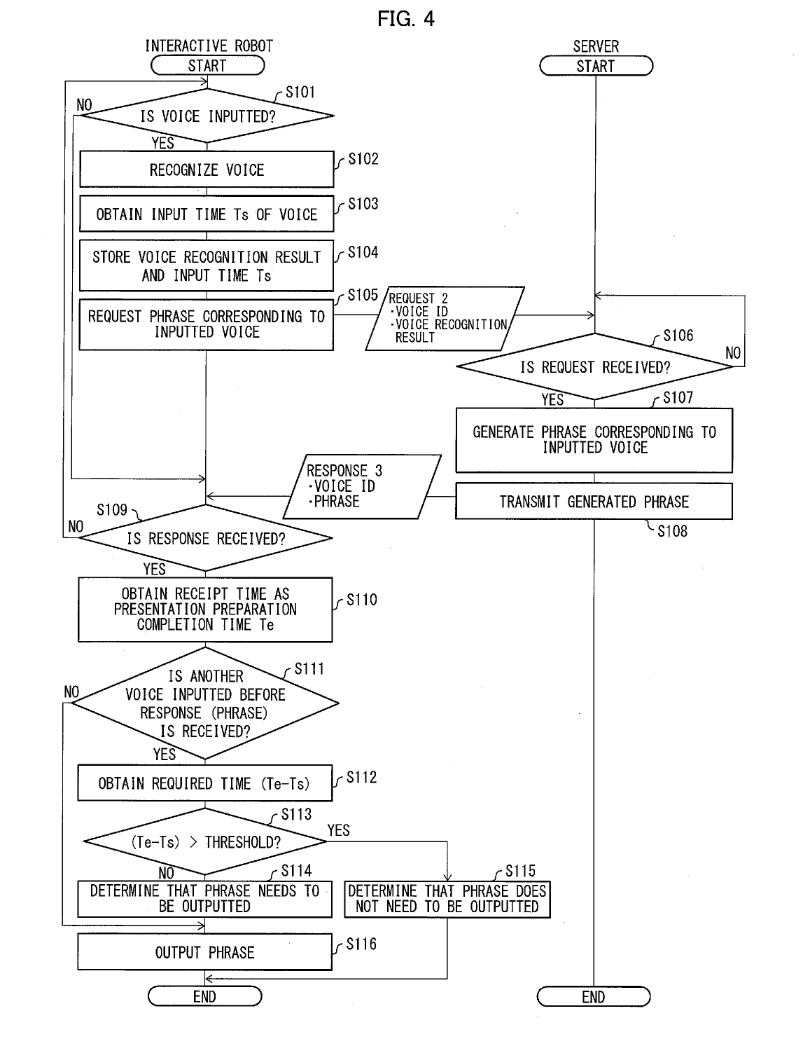

FIG. 4 is a flowchart illustrating a process performed by each device of the interactive system 300 of Embodiment 1. In a case where a voice of a speaker is inputted to the interactive robot 100 via the voice input section 13 (YES in S101), the voice recognition section 20 outputs a voice recognition result of the voice (S102). The input management section 21 obtains an input time Ts at which the voice was inputted (S103), and stores, in the voice management table 40a, the input time in association with information (a voice ID, the voice recognition result, and/or voice data) that identifies the voice (S104). Meanwhile, the phrase requesting section 24 generates a request 2 containing the voice recognition result, and transmits the request 2 to the server 200 so as to request, from the server 200, a phrase corresponding to the voice (S105).

Note that the request 2 preferably contains the voice ID so that it is possible to easily and accurately identify to which voice a phrase transmitted from the server 200 corresponds. Note also that, in a case where the voice recognition section 20 is provided in the server 200, the step S102 is omitted, and the request 2 which contains the voice data, instead of the voice recognition result, is generated.

In a case where the server 200 receives the request 2 via the phrase request receiving section 60 (YES in S106), the phrase generating section 61 generates, in accordance with the voice recognition result contained in the request 2, the phrase corresponding to the inputted voice (S107). The phrase transmitting section 62 transmits a response 3 containing the phrase thus generated to the interactive robot 100 (S108). In so doing, the phrase transmitting section 62 preferably incorporates the voice ID into the response 3.

In a case where the interactive robot 100 receives the response 3 via the phrase receiving section 25 (YES in S109), the input management section 21 obtains, as a presentation preparation completion time Te, a time at which the phrase receiving section 25 received the response 3, and stores, in the voice management table 40a, the presentation preparation completion time in association with the voice ID (S110).

The output necessity determination section 22 then determines whether or not another voice was newly inputted before the phrase receiving section 25 received the phrase contained in the response 3 (or another voice is newly inputted before the phrase output section 23 outputs the phrase) (S111). Specifically, the output necessity determination section 22 determines, with reference to the voice management table 40a ((a) of FIG. 3), whether or not there is a voice that was inputted (i) after the input time (7:00:10) of the voice Q002 corresponding to the phrase received (e.g., “It'll be sunny today.”) and (ii) before the presentation preparation completion time (7:00:17) of the phrase. In a case where there is a voice (in the example illustrated in (a) of FIG. 3, the voice Q003) that meets such a condition (YES in S111), the output necessity determination section 22 reads out the input time Ts and the presentation preparation completion time Te each correspond to the voice ID received in the step S109, and obtains a required time Te-Ts for the response (S112).

The output necessity determination section 22 compares the required time with the threshold 41a. In a case where the required time does not exceed the threshold 41a (NO in S113), the output necessity determination section 22 determines that the phrase needs to be outputted (S114). In accordance with such determination, the phrase output section 23 outputs the phrase corresponding to the voice ID (S116). In contrast, in a case where the required time exceeds the threshold 41a (YES in S113), the output necessity determination section 22 determines that the phrase does not need to be outputted (S115). In accordance with such determination, the phrase output section 23 does not output the phrase corresponding to the voice ID. Note here that, in a case where the output necessity determination section 22 determines that a phrase does not need to be outputted, the output necessity determination section 22 can delete the phrase from the voice management table 40a or can alternatively keep the phrase in the voice management table 40a together with a flag (not illustrated) indicating that the phrase does not need to be outputted.

Note that, in a case where there is no voice that meets the condition in S111 (NO in S111), the interactive robot 100 is communicating with a speaker on the one-response-to-one-question basis, and therefore it is not necessary to determine whether or not the phrase needs to be outputted. In such a case, the phrase output section 23 outputs the phrase received in the step S109 (S116).

### Embodiment 2

### Configuration of Interactive Robot

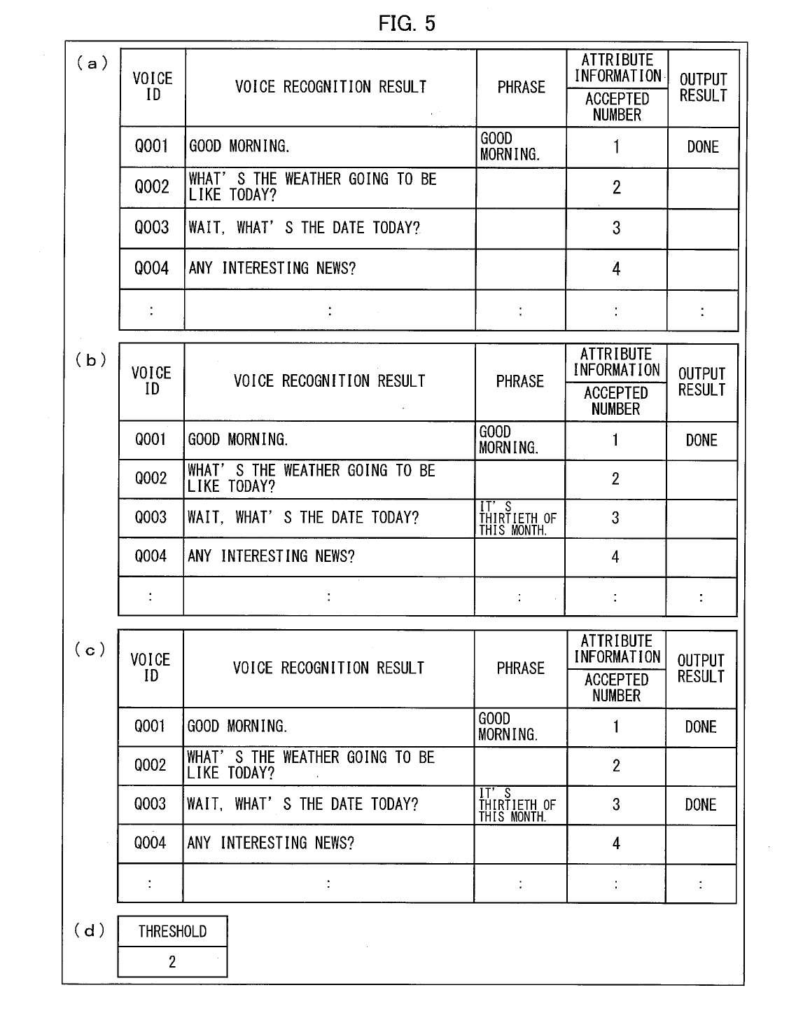

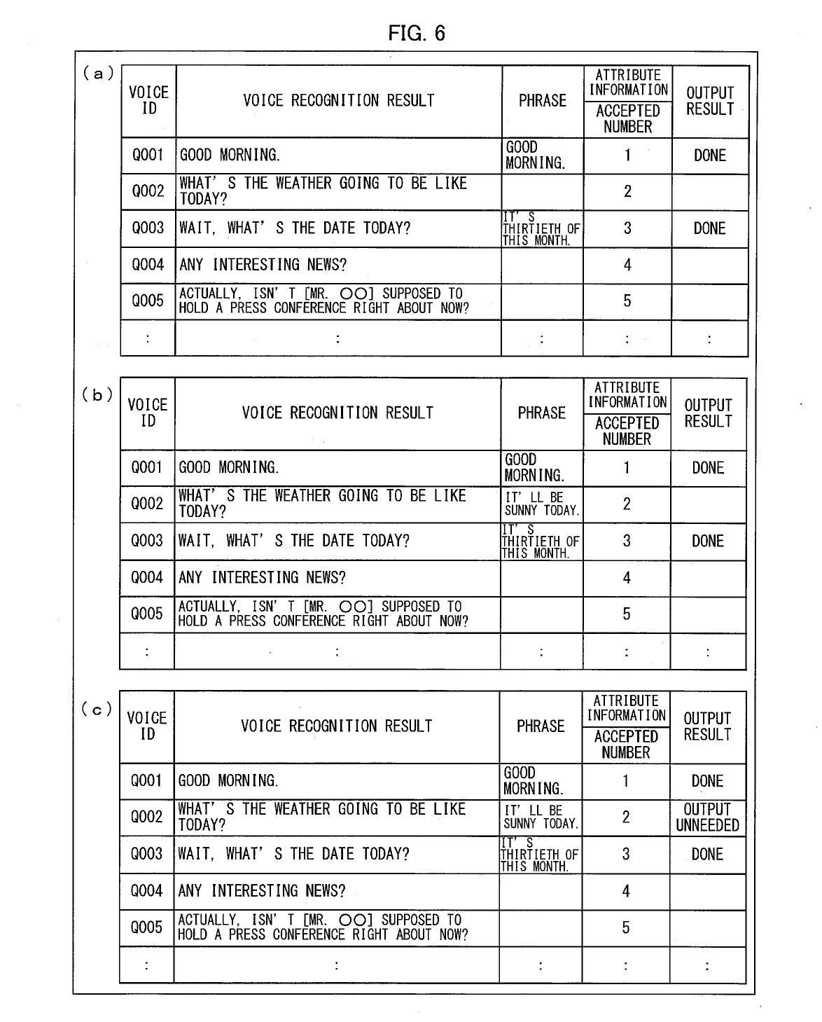

The following description will discuss Embodiment 2 of the present invention with reference to FIGS. 1 and 5 through 7. Note that, for convenience of description, members having functions identical to those of members described in Embodiment 1 are given respective identical reference numerals, and explanations thereof will be omitted. The same applies to the following embodiments. First, how an interactive robot 100 of Embodiment 2 illustrated in FIG. 1 differs from the interactive robot 100 of Embodiment 1 will be described below. According to Embodiment 2, a voice management table 40b, instead of the voice management table 40a, and a threshold 41b, instead of the threshold 41a, are stored in a storage section 12. (a) through (c) of FIG. 5 and (a) through (c) of FIG. 6 are views each illustrating a concrete example of the voice management table 40b of Embodiment 2. (d) of FIG. 5 is a view illustrating a concrete example of the threshold 41b of Embodiment 2.

The voice management table 40b of Embodiment 2 differs from the voice management table 40a of Embodiment 1 in the following point. That is, the voice management table 40b has a structure such that an accepted number is stored therein as attribute information. The accepted number indicates a position of a corresponding one of voices, in order in which the voices were inputted. A lower accepted number means that a corresponding voice was inputted earlier. Therefore, in the voice management table 40b, a voice associated with the highest accepted number is identified as the latest voice. According to Embodiment 2, in a case where a voice is inputted, an input management section 21 stores, in the voice management table 40b, a voice ID of the voice in association with an accepted number of the voice. After giving the accepted number to the voice, the input management section 21 increments the latest accepted number by one so as to prepare for next input of a voice.

Note that the voice management table 40b illustrated in each of FIGS. 5 and 6 includes a column of “OUTPUT RESULT” only for ease of understanding, and does not necessarily includes the column. Note also that “DONE,” a blank, and “OUTPUT UNNEEDED” in the column of “OUTPUT RESULT” indicates the following respective results. That is, “DONE” indicates that (i) an output necessity determination section 22 determined that a phrase corresponding to a voice needed to be outputted and (ii) the phrase was therefore outputted. The blank indicates that a phrase has not been made ready for output. “OUTPUT UNNEEDED” indicates that (i) a phrase was made ready for output but the output necessity determination section 22 determined that the phrase did not need to be outputted and (ii) the phrase was therefore not outputted. In a case where such an output result is managed in the voice management table 40b, the column only needs to be updated by the output necessity determination section 22.

According to Embodiment 2, the output necessity determination section 22 calculates, as a degree of newness, a difference between (i) an accepted number Nc of a voice (i.e., target voice) with respect to which the output necessity determination section 22 should determine whether or not a phrase needs to be outputted and (ii) an accepted number Nn of the latest voice. The degree of newness numerically indicates how new a target voice and a phrase corresponding to the target voice are. A higher value of the degree of newness (the difference) means an older voice and an older phrase in chronological order. The output necessity determination section 22 uses the degree of newness so as to determine whether or not a phrase needs to be outputted.

Specifically, the degree of newness which degree is adequately great indicates that the interactive robot 100 and a speaker have made many interactions (i.e., at least the speaker has talked to the interactive robot 100 many times) between (i) when a target voice was inputted and (ii) when the latest voice is inputted. Therefore, it is considered that an adequate time, to determine that a topic was changed to another, has elapsed between (i) a time point when the target voice was inputted and (ii) a present moment (latest time point of interaction). In such a case, the target voice and contents of a phrase corresponding to the target voice are likely to be too old to match contents of the latest interaction. In a case where the output necessity determination section 22 thus determines, in accordance the degree of newness, that the phrase is too old to be outputted, the output necessity determination section 22 controls a phrase output section 23 not to output the phrase. This allows a natural flow of the interaction to be maintained. In contrast, in a case where the degree of newness is adequately small, the target voice and the contents of the phrase corresponding to the target voice are highly likely to match the contents of the latest interaction. In such a case, the output necessity determination section 22 determines that output of the phrase will not interrupt a flow of the interaction, and permits the phrase output section 23 to output the phrase.

With reference to (a) through (d) of FIG. 5, a case where it is determined that a phrase needs to be outputted will be first described in detail. It is assumed that a speaker successively inputs three voices (Q002 through Q004) without waiting for a response from the interactive robot 100. In this case, the input management section 21 sequentially gives the three voices respective accepted numbers, and stores the accepted numbers together with respective corresponding voice recognition results ((a) of FIG. 5). It is now assumed that a phrase receiving section 25 first received a phrase “It's thirtieth of this month.” corresponding to the voice Q003, out of the three voices ((b) of FIG. 5). In this case, a target voice is the voice Q003. The output necessity determination section 22 therefore determines whether or not the phrase corresponding to the voice Q003 needs to be outputted. Specifically, the output necessity determination section 22 reads out the latest accepted number Nn (4 at a time point of (b) of FIG. 5) and an accepted number Nc (3) of the target voice, and calculates that a degree of newness is “1” from a difference (4−3) between the latest accepted number Nn and the accepted number Nc. The output necessity determination section 22 then compares the degree of newness of “1” with a threshold 41b of “2” (illustrated in (d) of FIG. 5), and determines that the degree of newness does not exceed the threshold 41b. That is, the degree of newness has an adequately low value, and it is accordingly considered that not so many interactions have been made as to consider that a topic was changed. The output necessity determination section 22 therefore determines that the phrase “It's thirtieth of this month.” needs to be outputted. In accordance with such determination, the phrase output section 23 outputs the phrase ((c) of FIG. 5).

Next, with reference to (a) through (d) of FIG. 6, a case where it is determined that a phrase does not need to be outputted will be described in detail. It is assumed that (i) the user further inputs a voice Q005 after the phrase corresponding to the voice Q003 was outputted and before a phrase corresponding to the voice Q002 is outputted ((a) of FIG. 6) and (ii) a phrase “It'll be sunny today.” corresponding to the voice Q002 is then received by the phrase receiving section 25 ((b) of FIG. 6). The output necessity determination section 22 determines, in the following manner, whether or not the phrase corresponding to the voice Q002, which is a target voice, needs to be outputted. That is, the output necessity determination section 22 reads out the latest accepted number Nn (5 at a time point of (b) of FIG. 6) and an accepted number Nc (2) of the target voice, and calculates that the degree of newness is “3” from a difference (5−2) between the latest accepted number Nn and the accepted number Nc. The output necessity determination section 22 then compares the degree of newness of “3” with the threshold 41b (2 in the example illustrated in (d) of FIG. 5), and determines that the degree of newness exceeds the threshold 41b. That is, the degree of newness has an adequately high value, and it is accordingly considered that so many interactions have been made as to consider that the topic was changed. The output necessity determination section 22 therefore determines that the phrase “It'll be sunny today.” does not need to be outputted ((c) of FIG. 6). In accordance with such determination, the phrase output section 23 cancels outputting the phrase. This prevents the interactive robot 100 from outputting a phrase about a weather-related topic at this time point, irrespective of the fact that a new topic about an event of the day has been raised at the latest time point of interaction.

[Process Flow]

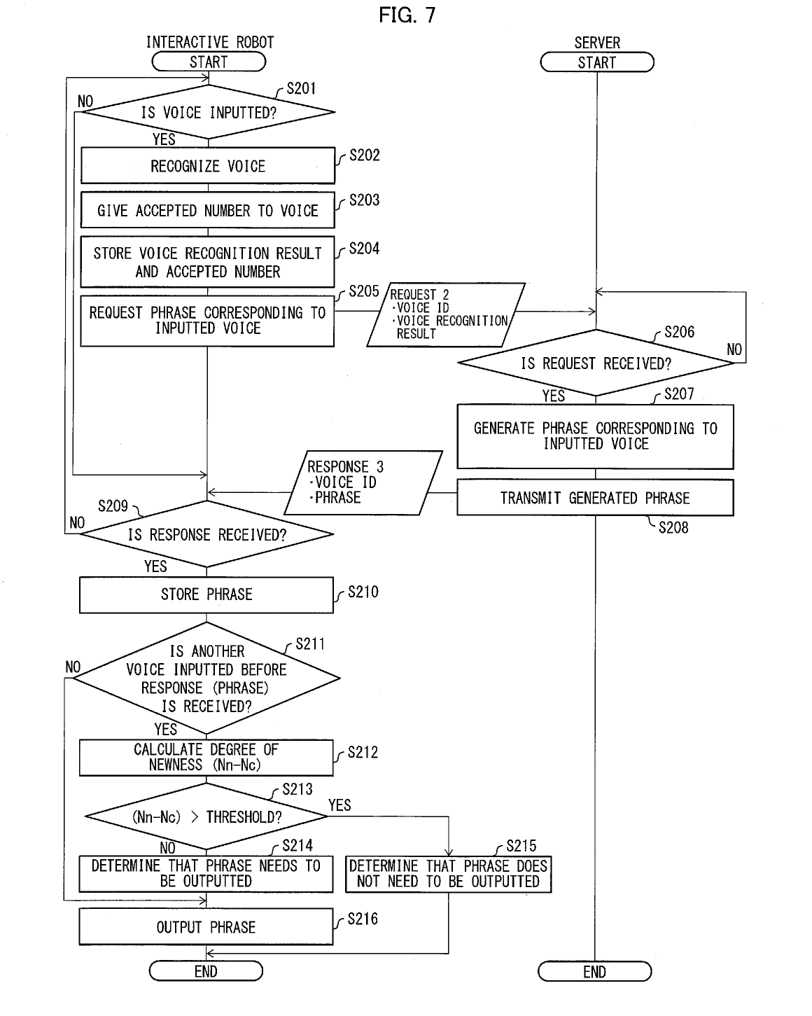

FIG. 7 is a flowchart illustrating a process performed by each device of an interactive system 300 of Embodiment 2.

As with the case of Embodiment 1, a voice is inputted to the interactive robot 100, and then the voice is recognized (S201 and S202). The input management section 21 gives an accepted number to the voice (S203), and stores, in the voice management table 40b, the accepted number in association with a voice ID (or a voice recognition result) of the voice (S204). Steps S205 through S209 are similar to the respective steps S105 through S109 of Embodiment 1.

The input management section 21 stores, in the voice management table 40b, a phrase, received in the step S209, in association with the voice ID also received in the step S209 (S210). Note that, in a case where the voice management table 40b has no column in which a phrase is stored, the step S210 can be omitted. Alternatively, the phrase can be temporarily stored in a temporary storage section (not illustrated), which is a volatile storage medium, instead of being stored in the voice management table 40b (storage section 12).

The output necessity determination section 22 then determines whether or not another voice was newly inputted before the phrase receiving section 25 received the phrase contained in a response 3 (S211). Specifically, the output necessity determination section 22 determines, with reference to the voice management table 40b ((b) of FIG. 5), whether or not the accepted number of the voice (i.e., target voice) to which the phrase corresponds is the latest number. In a case where the target voice is not the latest voice (YES in S211), the output necessity determination section 22 reads out an accepted number Nn of the latest voice and the accepted number Nc of the target voice, and calculates newness of each of the target voice and the phrase corresponding to the target voice, i.e., a degree of newness Nn−Nc (S212).

The output necessity determination section 22 compares the degree of newness with the threshold 41b. In a case where the degree of newness does not exceed the threshold 41b (NO in S213), the output necessity determination section 22 determines that the phrase needs to be outputted (S214). In contrast, in a case where the degree of newness exceeds the threshold 41b (YES in S213), the output necessity determination section 22 determines that the phrase does not need to be outputted (S215). A process carried out in S216 in a case of NO in S211 is similar to that of Embodiment 1, that is, a process carried out in S116 in a case of NO in S111. Note that the threshold 41b is a numerical value of not lower than 0 (zero).

[Variation]

In Embodiment 2, a process carried out in the step S211 illustrated in FIG. 7 can be omitted. Even in such a case, it is possible to achieve, for the following reason, a result similar to that achieved by processes, of Embodiment 2, illustrated in FIG. 7.

In a case where another voice was not inputted before a response 3 was received, an accepted number Nn of the latest voice and an accepted number Nc of a target voice are equal to each other, i.e., a degree of newness is 0 (zero) at a time point at which the process of the step S212 illustrated in FIG. 7 is to be performed. Since the degree of newness does not exceed the threshold 42b, which is a numerical value of not lower than 0 (zero) (NO in S213), it is determined that a phrase contained in the response 3 needs to be outputted (S214). In other words, the phrase contained in the response 3 is outputted, as with the case where it is determined, in the step S211 illustrated in FIG. 7, that the target voice is the latest voice (NO in S211).

In a case where the target voice is not the latest voice at the time point at which the process of the step S212 illustrated in FIG. 7 is to be performed, the processes in the steps following the step S212 illustrated in FIG. 7 are performed. The processes are similar to those performed in a case where it is determined, in the step S211 illustrated in FIG. 7, that the target voice is not the latest voice (YES in S211).

Thus, even with the above configuration, in a case where the latest voice is inputted before the phrase output section 23 causes a phrase corresponding to a target voice, which phrase is contained in a response 3, to be presented, the output necessity determination section 22 determines, in accordance with an accepted number of the target voice which accepted number is stored in the storage section, whether or not the phrase, contained in the response 3, needs to be outputted.

### Embodiment 3

### Configuration of Interactive Robot

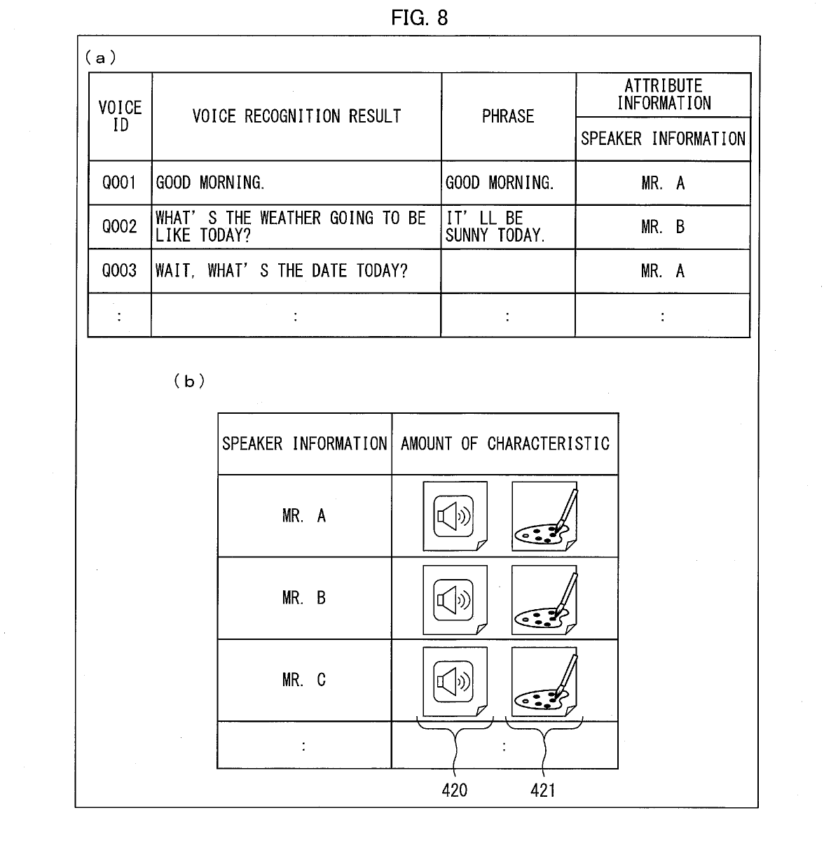

The following description will discuss Embodiment 3 of the present invention with reference to FIGS. 1, 8, and 9. First, how an interactive robot 100 of Embodiment 3 illustrated in FIG. 1 differs from the interactive robot 100 of each of Embodiments 1 and 2 will be described below. According to Embodiment 3, a voice management table 40c, instead of the voice management tables 40a and 40b, and a speaker database (DB) 42c, instead of the thresholds 41a and 41b, are stored in a storage section 12. (a) of FIG. 8 is a view illustrating a concrete example of the voice management table 40c of Embodiment 3. (b) of FIG. 8 is a view illustrating a concrete example of the speaker DB 42c of Embodiment 3.

The voice management table 40c of Embodiment 3 differs from each voice management table 40 of Embodiments 1 and 2 in that the voice management table 40c has a structure such that speaker information is stored therein as attribute information. The speaker information is information that identifies a speaker who uttered a voice. Note that the speaker information is not limited to particular information, provided that the speaker information can uniquely identify the speaker. Examples of the speaker information include a speaker ID, a speaker name, and a title or a nickname (e.g., Dad, Mom, Big bro., Bobby, etc.) of the speaker.

An input management section 21 of Embodiment 3 has a function of identifying a speaker who inputted a voice, that is, functions as a speaker identification section. For example, the input management section 21 analyzes voice data of an inputted voice, and identifies a speaker in accordance with a characteristic of the inputted voice. As illustrated in (b) of FIG. 8, sample voice data 420 is registered in the speaker DB 42c in association with the speaker information. The input management section 21 identifies a speaker who inputted a voice, by comparing voice data of the voice with the sample data 420. Alternatively, in a case where the interactive robot 100 includes a camera, the input management section 21 can identify a speaker by face recognition in which an image of the speaker, captured by the camera, is compared with sample speaker-face data 421. Note that a method of identifying a speaker can be realized by a conventional technique, and the method will not be described in detail.

An output necessity determination section 22 of Embodiment 3 determines whether or not a phrase corresponding to a target voice needs to be outputted, in accordance with whether or not speaker information Pc associated with the target voice matches speaker information Pn associated with the latest voice. This process will be described in detail with reference to (a) of FIG. 8. It is assumed that the interactive robot 100 receives, from a server 200, a phrase corresponding to a voice Q002 after receiving successive input of the voice Q002 and a voice Q003. According to the voice management table 40c illustrated in (a) of FIG. 8, speaker information Pc associated with the voice Q002, which is a target voice, indicates “Mr. B,” and speaker information Pn associated with the voice Q003, which is the latest voice, indicates “Mr. A.” In this case, the speaker information Pc does not match the speaker information Pn. Therefore, the output necessity determination section 22 determines that the phrase “It'll be sunny today.” corresponding to the voice Q002, which is a target voice, does not need to be outputted. In contrast, in a case where the speaker information Pn associated with the latest voice indicates “Mr. B,” the output necessity determination section 22 determines that the phrase corresponding to the target voice needs to be outputted, because the speaker information Pn associated with the latest voice matches the speaker information Pc associated with the target voice.

[Process Flow]

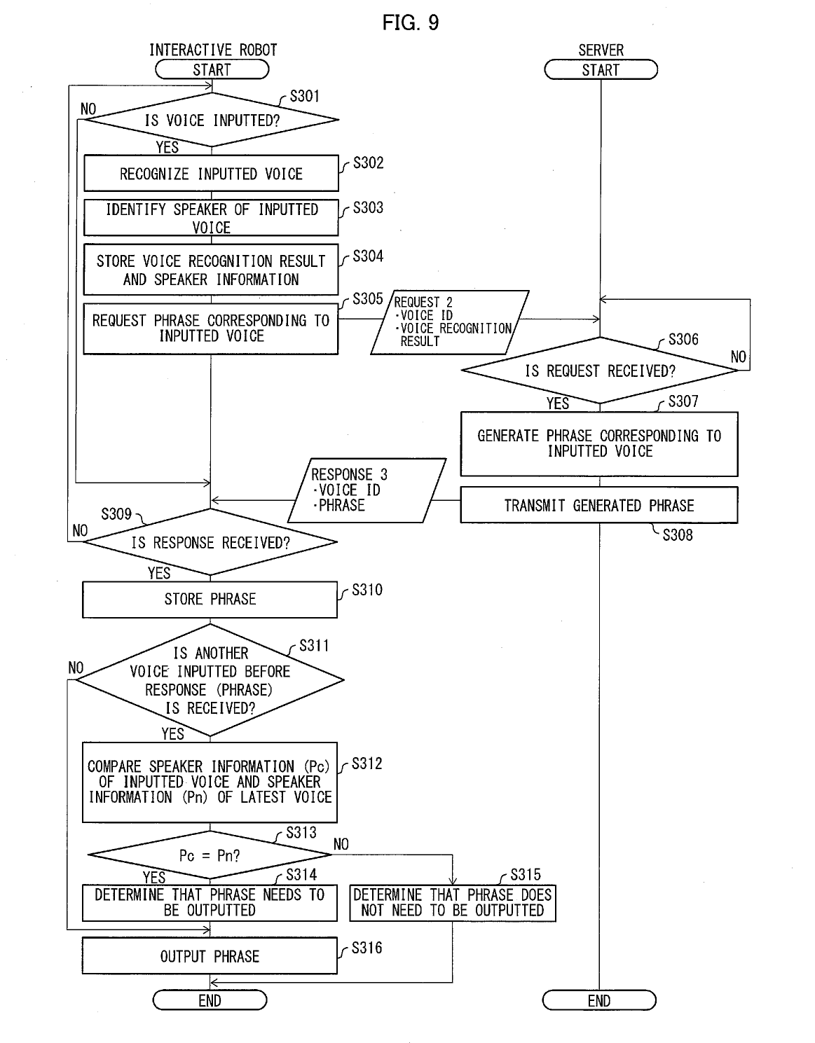

FIG. 9 is a flowchart illustrating a process performed by each device of an interactive system 300 of Embodiment 3. As with the case of Embodiments 1 and 2, a voice is inputted to the interactive robot 100, and then the voice is recognized (S301 and S302). The input management section 21 identifies, with reference to the speaker DB 42c, a speaker who inputted the voice (S303), and stores, in the voice management table 40c, speaker information on the speaker thus identified in association with a voice ID (or a voice recognition result) of the voice (S304). Steps S305 through S310 are similar to the respective steps S205 through S210 of Embodiment 2.

In a case where a phrase is supplied from the server 200 and is stored in the voice management table 40c, the output necessity determination section 22 then determines whether or not another voice was newly inputted before a phrase receiving section 25 received the phrase contained in a response 3 (S311). Specifically, the output necessity determination section 22 determines, with reference to the voice management table 40c ((a) of FIG. 8), whether or not there is a voice that was newly inputted after the voice Q002, which is a target voice and to which the phrase corresponds, was inputted. In a case where there is a voice Q003 that meets this condition (YES in S311), the output necessity determination section 22 reads out and compares (i) the speaker information Pc associated with the target voice and (ii) speaker information Pn associated with the latest voice (S312).

In a case where the speaker information Pc matches the speaker information Pn (YES in S313), the output necessity determination section 22 determines that the phrase needs to be outputted (S314). In contrast, in a case where the speaker information Pc does not match the speaker information Pn (NO in S313), the output necessity determination section 22 determines that the phrase does not need to be outputted (S315). Note that a process carried out in S316 in a case of NO in S311 is similar to that of Embodiment 2, that is, a process carried out in S216 in a case of NO in S211.

### Embodiment 4

### Configuration of Interactive Robot

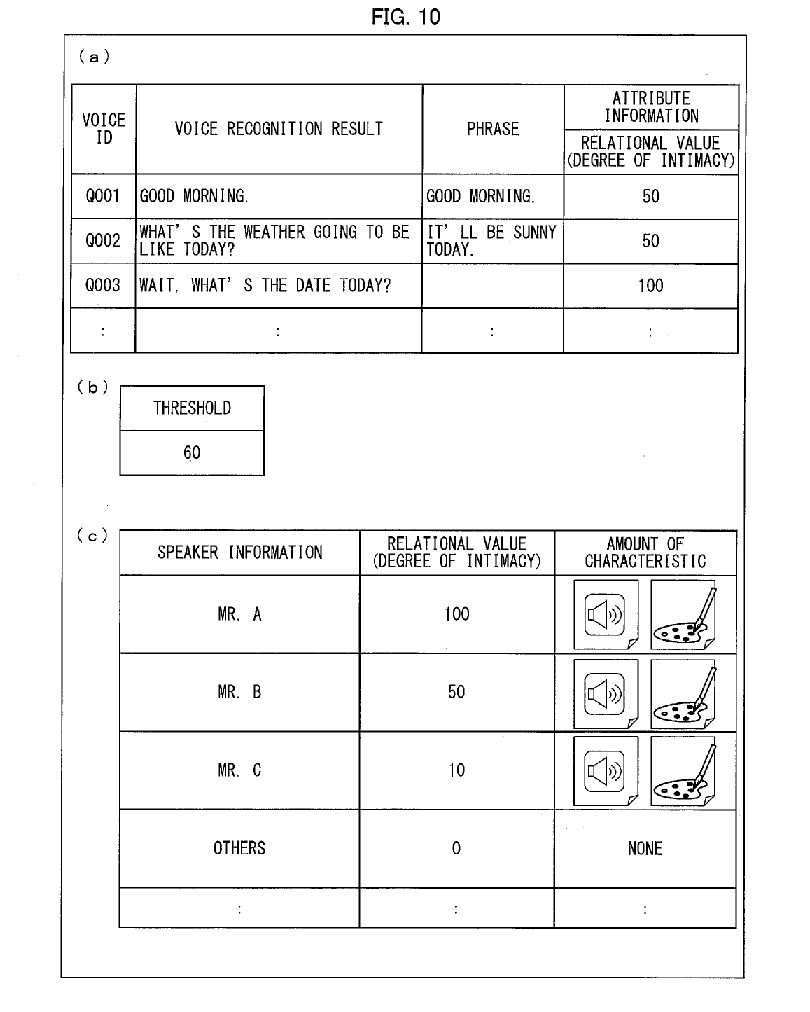

The following description will discuss Embodiment 4 of the present invention with reference to FIGS. 1 and 10 through 12. First, how an interactive robot 100 of Embodiment 4 illustrated in FIG. 1 differs from the interactive robot 100 of Embodiment 3 will be described below. According to Embodiment 4, a threshold 41d and a speaker DB 42d, instead of the speaker DB 42c, are stored in a storage section 12. Note that, as with the case of Embodiment 3, a voice management table 40c ((a) of FIG. 8) is stored in the storage section 12 as a voice management table. Alternatively, a voice management table 40d ((a) of FIG. 10), instead of the voice management table 40c, can be stored in the storage section 12. (a) of FIG. 10 is a view illustrating another concrete example of the voice management table (voice management table 40d) of Embodiment 4. (b) of FIG. 10 is a view illustrating a concrete example of the threshold 41d of Embodiment 4. (c) of FIG. 10 is a view illustrating a concrete example of the speaker DB 42d of Embodiment 4.

As with the case of Embodiment 3, an input management section 21 of Embodiment 4 stores, in the voice management table 40c, speaker information indicative of an identified speaker as attribute information in association with a voice. According to another example, the input management section 21 can obtain, from the speaker DB 42d illustrated in (c) of FIG. 10, a relational value associated with the identified speaker, and store the relational value as attribute information in the voice management table 40d ((a) of FIG. 10) in association with the voice.

The relational value numerically indicates a relationship between the interactive robot 100 and a speaker. The relational value can be calculated by application of a relationship, between the interactive robot 100 and a speaker or between an owner of the interactive robot 100 and a speaker, to a given formula or a given conversion rule. The relational value allows a relationship between the interactive robot 100 and a speaker to be objectively quantified. That is, by using the relational value, an output necessity determination section 22 is capable of determining, in accordance with a relationship between the interactive robot 100 and a speaker, whether or not a phrase needs to be outputted. For example, in Embodiment 4, a degree of intimacy, which numerically indicates intimacy between the interactive robot 100 and a speaker, is employed as the relational value. The degree of intimacy is pre-calculated in accordance with, for example, whether or not the speaker is the owner of the interactive robot 100 or how frequently the speaker interacts with the interactive robot 100. As illustrated in (c) of FIG. 10, the degree of intimacy is stored in the speaker DB 42d in association with each speaker. In the example illustrated in (c) of FIG. 10, a higher value of the degree of intimacy indicates that the interactive robot 100 and a speaker have a more intimate relationship therebetween. Note, however, that the degree of intimacy is not limited to such, and can be alternatively set such that a lower value of the degree of intimacy indicates that the interactive robot 100 and a speaker have a more intimate relationship therebetween.

According to Embodiment 4, the output necessity determination section 22 compares a relational value Rc, associated with a speaker of a target voice, with the threshold 41d, and determines, in accordance with a result of such comparison, whether or not a phrase corresponding to the target voice needs to be outputted. This process will be described in detail with reference to (a) of FIG. 8 and (b) and (c) of FIG. 10. It is assumed that the interactive robot 100 receives a phrase corresponding to a voice Q002 from a server 200 after receiving successive input of the voice Q002 and a voice Q003. According to the voice management table 40c illustrated in (a) of FIG. 8, speaker information Pc associated with the voice Q002, which is a target voice, indicates “Mr. B.” Therefore, the output necessity determination section 22 obtains, from the speaker DB 42d ((c) of FIG. 10), a degree of intimacy “50” associated with the speaker information indicating “Mr. B.” The output necessity determination section 22 compares the degree of intimacy with the threshold 41d (“60” in (b) of FIG. 10). In this case, the degree of intimacy does not exceed the threshold. This means that Mr. B, who is a speaker of the target voice, and the interactive robot 100 are not intimate with each other. The output necessity determination section 22 accordingly determines that the phrase “It'll be sunny today.” corresponding to the voice (voice Q002, which is the target voice) of Mr. B, who is not so intimate with the interactive robot 100, does not need to be outputted. In contrast, in a case where the speaker of the voice Q002, which is the target voice, is Mr. A, a corresponding degree of intimacy “100”, which exceeds the threshold of “60”. This means that Mr. A, who is a speaker of the target voice, and the interactive robot 100 are intimate with each other. The output necessity determination section 22 therefore determines that the phrase needs to be outputted.

[Process Flow]

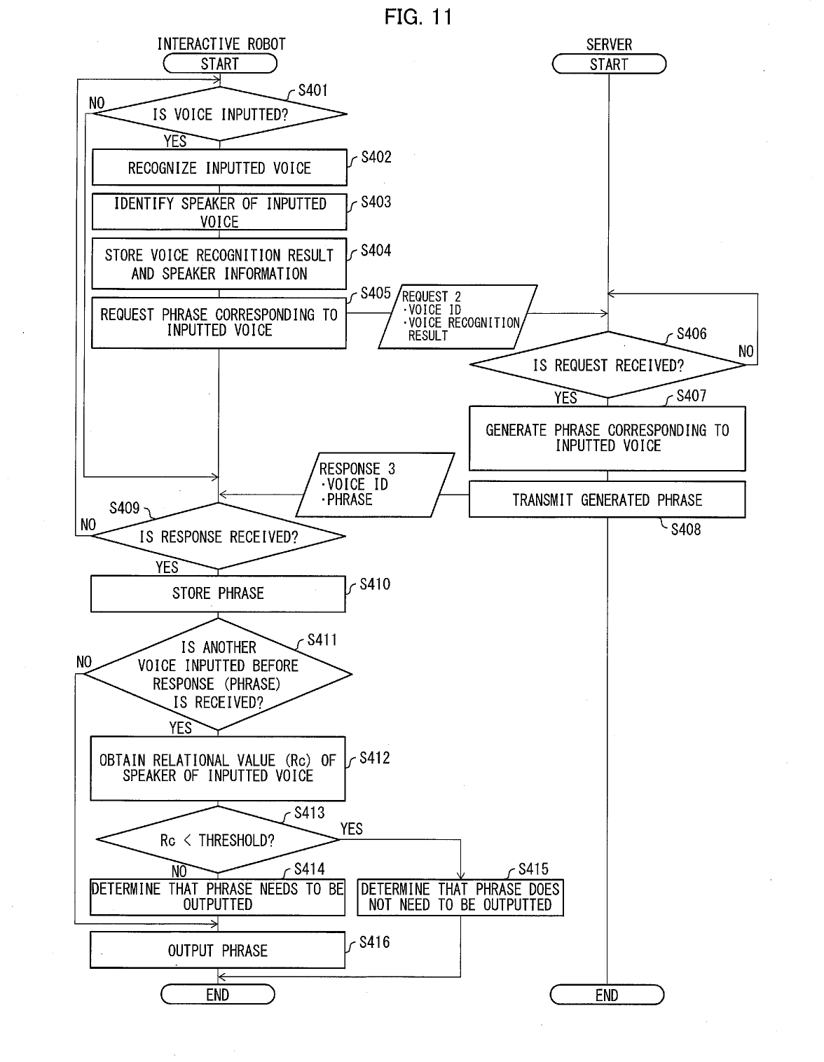

FIG. 11 is a flowchart illustrating a process performed by each device of an interactive system 300 of Embodiment 4. According to the interactive robot 100, steps S401 through S411 are similar to the respective steps S301 through S311 of Embodiment 3. Note that, in a case where the voice management table 40d ((a) of FIG. 10), instead of the voice management table 40c, is stored in the storage section 12, the input management section 21 stores, in the step S404, a relational value (degree of intimacy) associated with a speaker identified in the step S403, instead of speaker information, as attribute information in the voice management table 40d.

In a case where there is a voice (in (a) of FIG. 8, Q003) that meets a condition in the step S411 (YES in S411), the output necessity determination section 22 obtains, from the speaker DB 42d, a relational value Rc which is associated with speaker information Pc associated with a target voice (S412).

The output necessity determination section 22 compares the threshold 41b with the relational value Rc. In a case where the relational value Rc (degree of intimacy) exceeds the threshold 41d (NO in S413), the output necessity determination section 22 determines that a phrase received in the step S409 needs to be outputted (S414). In contrast, in a case where the relational value Rc does not exceed the threshold 41d (YES in S413), the output necessity determination section 22 determines that the phrase does not need to be outputted (S415). A process carried out in S416 in a case of NO in S411 is similar to that of Embodiment 3, that is, a process carried out in S316 in a case of NO in S311.

### Embodiment 5

In Embodiments 1 through 4, the output necessity determination section 22 is configured to determine, in a case where a plurality of voices are successively inputted, whether or not a phrase corresponding to an earlier one of the plurality of voices needs to be outputted. According to Embodiment 5, in a case where (i) an output necessity determination section 22 has determined that the phrase corresponding to the earlier one of the plurality of voices needs to be outputted and (ii) output of a phrase corresponding to a later one of the plurality of voices has not been completed yet, the output necessity determination section 22 further determines, in consideration of the fact that the phrase corresponding to the earlier one of the plurality of voices is to be outputted, whether or not the phrase corresponding to the later one of the plurality of voices needs to be outputted. The output necessity determination section 22 can make such determination by a method similar to that by which the output necessity determination section 22 makes determination with respect to a phrase corresponding to an earlier voice in Embodiments 1 through 4.

The above configuration allows the following problem to be solved. For example, in a case where (i) a first voice, which is an earlier voice, and a second voice, which a later voice, were successively inputted, (ii) a first phrase corresponding to the first voice has been outputted (it has been determined that the first phrase is to be outputted), and then (iii) a second phrase corresponding to the second voice is outputted, it may cause an interaction to be unnatural. In Embodiments 1 through 4, determination of whether or not the second phrase needs to be outputted is not made unless a third voice is inputted successively to the second voice. Therefore, it is not possible to reliably avoid such an unnatural interaction.

In view of this, according to Embodiment 5, in a case where a first phrase corresponding to a first voice is outputted, it is determined whether or not a phrase corresponding to a second voice needs to be outputted, even in a case where a third voice is not inputted. This makes it possible to avoid circumstances such that a second phrase is absolutely outputted after the first phrase is outputted. It is therefore possible to omit output of an unnatural phrase depending on a situation and thereby achieve a more natural interaction between the interactive robot 100 and a speaker.

<<Variations>>

[Voice Recognition Section 20]

The voice recognition section 20 can be alternatively provided in the server 200 instead of being provided in the interactive robot 100. In such a case, the voice recognition section 20 is provided between the phrase request receiving section 60 and the phrase generating section 61 in the control section 50 of the server 200. Furthermore, in such a case, a voice ID, voice data, and attribute information of an inputted voice are stored in the voice management table (40a, 40b, 40c, or 40d) of the interactive robot 100, but no voice recognition result of the inputted voice is stored in the voice management table (40a, 40b, 40c, or 40d) of the interactive robot 100. Instead, the voice ID, a voice recognition result, and a phrase are stored, for each inputted voice, in a second voice management table (81a, 81b, 81c, or 81d) of the server 200. Specifically, the phrase requesting section 24 transmits an inputted voice as a request 2 to the server 200. The phrase request receiving section 60 recognizes the inputted voice, and the phrase generating section 61 generates a phrase in accordance with such a voice recognition result. The interactive system 300 thus configured brings about an effect similar to those brought about in Embodiments 1 through 5.

[Phrase Generating Section 61]

The interactive robot 100 can alternatively be configured (i) not to communicate with the server 200 and (ii) to locally generate a phrase. That is, the phrase generating section 61 can be provided in the interactive robot 100, instead of being provided in the server 200. In such a case, the phrase set or phrase material collection 80 is stored in the storage section 12 of the interactive robot 100. Furthermore, in such a case, the interactive robot 100 can omit the communication section 11, the phrase requesting section 24, and the phrase receiving section 25. That is, the interactive robot 100 can solely achieve (i) generation of a phrase and (ii) a method, of the present invention, of controlling an interaction.

[Output Necessity Determination Section 22]

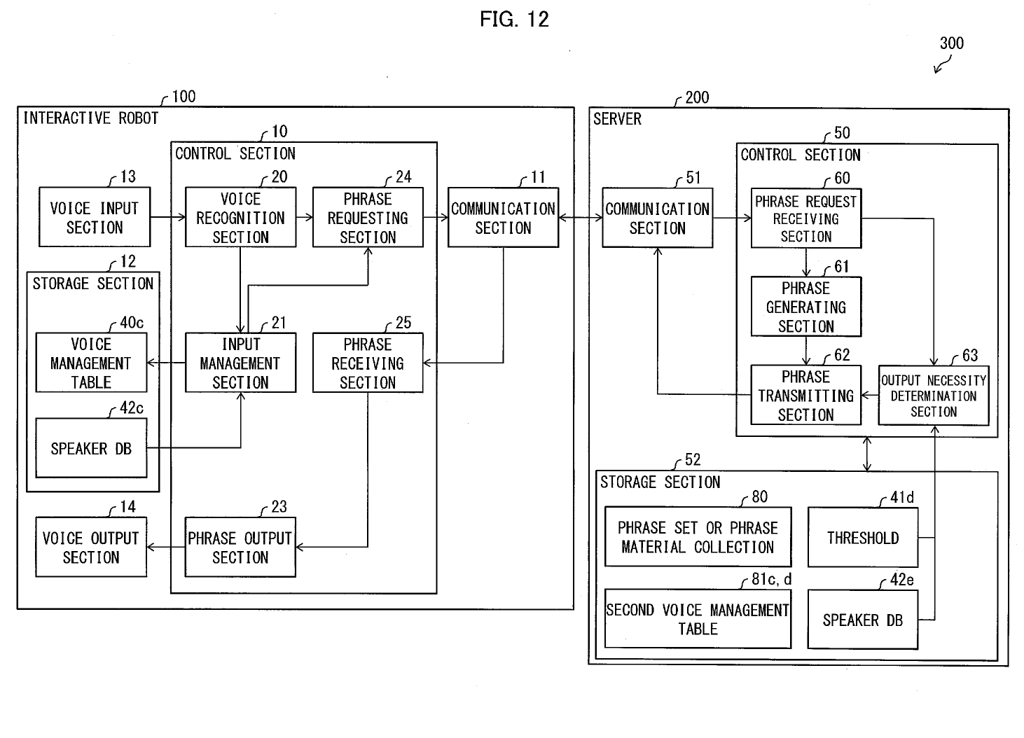

In Embodiment 4, the output necessity determination section 22 can alternatively be provided in the server 200, instead of being provided in the interactive robot 100. FIG. 12 is a view illustrating another example configuration of a main part of each of the interactive robot 100 and the server 200 of Embodiment 4. An interactive system 300 of the present variation illustrated in FIG. 12 differs from the interactive system 300 of Embodiment 4 in the following points. That is, according to the variation, a control section 10 of the interactive robot 100 does not include an output necessity determination section 22, but a control section 50 of the server 200 includes an output necessity determination section (determination section) 63. Further, a threshold 41d is stored in a storage section 52, instead of being stored in the storage section 12. Furthermore, a speaker DB 42e is stored in the storage section 52. Note that the speaker DB 42e has a data structure such that speaker information is stored therein in association with a relational value. Moreover, a second voice management table 81c (or 81d) is stored in the storage section 52. According to the present variation, the second voice management table 81c has a data structure such that a voice ID, a voice recognition result, and a phrase are stored for each inputted voice in association with attribute information (speaker information) on the each inputted voice.

Since the interactive robot 100 does not determine whether or not a phrase needs to be outputted, it is not necessary to retain, in the storage section 12, a relational value for each speaker. That is, the storage section 12 only needs to store therein a speaker DB 42c ((b) of FIG. 8) instead of the speaker DB 42d ((c) of FIG. 10). Note that, in a case where the server 200 has a function (speaker identification section) of identifying a speaker, which function the input management section 21 has, the storage section 12 does not necessarily store therein the speaker DB 42c.

According to the present variation, in a case where a voice is inputted to the interactive robot 100, the input management section 21 identifies, with reference to the speaker DB 42c, a speaker of the voice, and supplies speaker information on the speaker to the phrase requesting section 24. The phrase requesting section 24 transmits, to the server 200, a request 2 containing (i) a voice recognition result of the voice, which result is supplied from the voice recognition section 20, and (ii) a voice ID and the speaker information associated with the voice, each of which is supplied from the input management section 21.

The phrase request receiving section 60 stores, in the second voice management table 81c, the voice ID, the voice recognition result, and attribute information (speaker information) contained in the request 2. The phrase generating section 61 generates a phrase corresponding to the voice, in accordance with the voice recognition result. The phrase thus generated is temporarily stored in the second voice management table 81c.

As with the case of the output necessity determination section 22 of Embodiment 4, in a case where the output necessity determination section 63 determines, with reference to the second voice control table 81c, that another voice was inputted after a target voice for which a phrase was generated had been inputted, the output necessity determination section 63 determines whether or not the phrase needs to be outputted. Specifically, as with the case of Embodiment 4, the output necessity determination section 63 compares a relational value, associated with a speaker of the target voice, with the threshold 41d, and determines whether or not the phrase needs to be outputted, depending on whether or not the relational value meets a given condition.

In a case where the output necessity determination section 63 determines that the phrase needs to be outputted, a phrase transmitting section 62 transmits, in accordance with such determination, the phrase to the interactive robot 100. In contrast, in a case where the output necessity determination section 63 determines that the phrase does not need to be outputted, the phrase transmitting section 62 does not transmit the phrase to the interactive robot 100. In such a case, the phrase transmitting section 62 can transmit, as a response 3 to a request 2 and instead of the phrase, a message notifying that the phrase does not need to be outputted, to the interactive robot 100. The interactive system 300 thus configured brings about an effect similar to that brought about in Embodiment 4.

[Relational Value]

Embodiment 4 has described an example in which the degree of intimacy is employed as the relational value that the output necessity determination section 22 uses to determine whether or not a phrase needs to be outputted. However, the interactive robot 100 of the present invention is not limited to this configuration, and can employ other types of relational values. Concrete examples of such other types of relational values will be described below.

A mental distance numerically indicates a connection between the interactive robot 100 and a speaker. A smaller value of the mental distance means a smaller distance, i.e., the interactive robot 100 and a speaker have a closer connection therebetween. In a case where the mental distance between the interactive robot 100 and a speaker of a target voice is not smaller than a given threshold (i.e., in a case where the interactive robot 100 and the speaker do not have a close connection therebetween), the output necessity determination section 22 determines that a phrase corresponding to the target voice does not need to be outputted. The mental distance is set such that for example, (i) the smallest value of the mental distance is assigned to an owner of the interactive robot 100 and (ii) greater values are assigned to a relative of the owner, a friend of the owner, anyone else whom the owner does not really know, etc. in this order. In such a case, a response of a phrase to a speaker having a closer connection with the interactive robot 100 (or with its owner) is more prioritized.

A physical distance numerically indicates a physical distance that lies between the interactive robot 100 and a speaker while they are interacting with each other. For example, in a case where a voice is inputted, the input management section 21 (i) obtains the physical distance in accordance with a sound volume of the voice, a size of a speaker captured by a camera, or the like and (ii) stores, in the voice management table 40, the physical distance as attribute information in association with the voice. In a case where the physical distance between the interactive robot 100 and a speaker of a target voice is not smaller than a given threshold (i.e., in a case where a speaker talked to the interactive robot 100 from afar), the output necessity determination section 22 determines that a phrase corresponding to the target voice does not need to be outputted. In such a case, a response to another speaker who is interacting with the interactive robot 100 in its vicinity is prioritized.

A degree of similarity numerically indicates similarity between a virtual characteristic of the interactive robot 100 and a characteristic of a speaker. A greater value of the degree of similarity means that the interactive robot 100 and a speaker are more similar, in characteristic, to each other. For example, in a case where the degree of similarity between the interactive robot 100 and a speaker of a target voice is not greater than a given threshold (i.e., in a case where the interactive robot 100 and the speaker are not similar, in characteristic, to each other), the output necessity determination section 22 determines that a phrase corresponding to the target voice does not need to be outputted. Note that a characteristic (personality) of a speaker can be determined based on, for example, information (e.g., sex, age, occupation, blood type, zodiac sign, etc.) pre-inputted by the speaker. In addition to or instead of such information, the characteristic (personality) of the speaker can be determined based on a speech pattern, a speech speed, and the like of the speaker. The characteristic (personality) of the speaker thus determined is compared with the virtual characteristic (virtual personality) pre-set in the interactive robot 100, and the degree of similarity is calculated in accordance with a given formula. Use of the degree of similarity thus calculated allows a response of a phrase to a speaker who is similar in characteristic (personality) to the interactive robot 100 to be prioritized.

[Function of Adjusting Threshold]

In Embodiments 1 and 2, the thresholds 41a and 41b, to which the output necessity determination section 22 refers so as to determine whether or not a phrase needs to be outputted, are not necessarily fixed. Alternatively, the thresholds 41a and 41b can be dynamically adjusted based on an attribute of a speaker of a target voice. As the attribute of the speaker, for example, the relational value such as the degree of intimacy, which is employed in Embodiment 4, can be used.

Specifically, the output necessity determination section 22 changes a threshold so that a condition on which it is determined that a phrase (response) needs to be outputted becomes looser for a speaker having a higher degree of intimacy. For example, in Embodiment 1, in a case where a speaker of a target voice has a degree of intimacy of 100, the output necessity determination section 22 can extend the number of seconds, serving as the threshold 41a, from 5 seconds to 10 seconds, and determine whether or not a phrase needs to be outputted. This allows a response of a phrase to a speaker having a closer relationship with the interactive robot 100 to be prioritized.

[Software Implementation Example]

Control blocks of the interactive robot 100 (and the server 200) (particularly, each section of the control section 10 and the control section 50) can be realized by a logic circuit (hardware) provided in an integrated circuit (IC chip) or the like or can be alternatively realized by software as executed by a central processing unit (CPU). In the latter case, the interactive robot 100 (server 200) includes: a CPU which executes instructions of a program that is software realizing the foregoing functions; a read only memory (ROM) or a storage device (each referred to as “storage medium”) in which the program and various kinds of data are stored so as to be readable by a computer (or a CPU); and a random access memory (RAM) in which the program is loaded. The object of the present invention can be achieved by a computer (or a CPU) reading and executing the program stored in the storage medium. Examples of the storage medium encompass “a non-transitory tangible medium” such as a tape, a disk, a card, a semiconductor memory, and a programmable logic circuit. The program can be made available to the computer via any transmission medium (such as a communication network or a broadcast wave) which allows the program to be transmitted. Note that the present invention can also be achieved in the form of a computer data signal in which the program is embodied via electronic transmission and which is embedded in a carrier wave.

[Main Points]

An information processing device (interactive robot 100) of a first aspect of the present invention is an information processing device that presents a given phrase to a user (speaker) in response to a voice uttered by the user, the given phrase including a first phrase and a second phrase, the voice including a first voice and a second voice, the first voice being one that was inputted earlier than the second voice, the information processing device comprising: a storage section; an accepting section (input management section 21) that accepts the voice which was inputted, by storing, in the storage section (the voice management table 40 of the storage section 12), the voice (voice data) or a recognition result of the voice (voice recognition result) in association with attribute information indicative of an attribute of the voice; a presentation section (phrase output section 23) that presents the given phrase corresponding to the voice accepted by the accepting section; and a determination section (output necessity determination section 22) that, in a case where the second voice is inputted before the presentation section presents the first phrase corresponding to the first voice, determines, in accordance with at least one piece of attribute information stored in the storage section, whether or not the first phrase needs to be presented.

According to the above configuration, in a case where the first voice and the second voice are successively inputted, the accepting section stores, in the storage section, (i) attribute information on the first voice and (ii) attribute information on the second voice. In the case where the second voice is inputted before the first phrase corresponding to the first voice is presented, the determination section determines whether or not the first phrase needs to be presented, in accordance with at least one of those pieces of the attribute information stored in the storage section.

This makes it possible to cancel, depending on a situation of an interaction, presenting the first phrase corresponding to the first voice, which has been inputted earlier than the second voice, after the second voice is inputted. In a case where a plurality of voices are successively inputted, a more natural interaction may be achieved, depending on a situation, by responding to later ones of the plurality of voices without responding to an earlier one of the plurality of voices. According to the present invention, it is possible to, as a result, appropriately omit an unnatural response in accordance with attribute information and accordingly achieve a more natural (human-like) interaction between a user and the information processing device.

In a second aspect of the present invention, the information processing device is preferably arranged such that, in the first aspect of the present invention, in a case where the determination section determines that the first phrase needs to be presented, the determination section determines, in accordance with the at least one piece of attribute information stored in the storage section, whether or not the second phrase corresponding to the second voice needs to be presented.

According to the above configuration, in a case where (i) the first voice and the second voice are successively inputted and (ii) the determination section determines that the first phrase needs to be presented, the determination section further determines whether or not the second phrase needs to be presented. This makes it possible to avoid circumstances such that the second phrase is absolutely presented after the first phrase is presented. In a case where a response has been made to an earlier voice, a more natural interaction may be achieved, depending on the situation, by omitting a response to a later voice. According to the present invention, it is possible to, as a result, appropriately omit an unnatural response in accordance with attribute information and accordingly achieve a more natural (human-like) interaction between a user and the information processing device.

In a third aspect of the present invention, the information processing device is preferably arranged such that, in the first or the second aspect of the present invention, the accepting section incorporates, into the attribute information, (i) an input time at which the voice was inputted or (ii) an accepted number of the voice; and the determination section determines whether or not the given phrase needs to be presented, in accordance with at least one of the input time, the accepted number, and another piece of attribute information which is determined by use of the input time or the accepted number.

According to the above configuration, in a case where the first voice and the second voice are successively inputted, whether or not a phrase corresponding to each of the first voice and the second voice needs to be presented is determined in accordance with at least an input time or an accepted number of the each of the first voice and the second voice or in accordance with another piece of attribute information that is determined by use of the input time or the accepted number.

This makes it possible to omit a response, in a case where making the response to a voice is unnatural because the voice was inputted long time ago. Since an interaction progresses as time goes by, it is unnatural (i) to respond to a voice after a long time has elapsed since the voice was inputted or (ii) to respond to a voice after many voices are inputted subsequent to the voice. According to the present invention, it is possible to, as a result, prevent such an unnatural interaction.

In a fourth aspect of the present invention, the information processing device can be arranged such that, in the third aspect of the present invention, the determination section determines that the given phrase does not need to be presented, in a case where a time (required time), between (i) the input time of the voice and (ii) a presentation preparation completion time at which the given phrase is made ready for presentation by being generated by the information processing device or being obtained from an external device (server 200), exceeds a given threshold.

This makes it possible to omit presentation of a response, in a case where it is unnatural to make the response to a voice because a long time has elapsed since the voice was inputted.

In a fifth aspect of the present invention, the information processing device can be arranged such that, in the third aspect of the present invention, the accepting section further incorporates an accepted number of each voice into the attribute information; and the determination section determines that, in a case where a difference (degree of newness), between (i) an accepted number of the most recently inputted voice (an accepted number Nn of the latest voice) and (ii) an accepted number of a voice (an accepted number Nc of a target voice) which was inputted earlier than the most recently inputted voice and may be the first voice or the second voice, exceeds a given threshold, a phrase corresponding to the voice inputted earlier than the most recently inputted voice does not need to be presented.

This makes it possible to omit presentation of a response to an earlier voice, in a case where it is unnatural to respond to the earlier voice because many voices have been successively inputted after the earlier voice was inputted (or because many responses have been made to the many voices after the earlier voice was inputted).

In a sixth aspect of the present invention, the information processing device is arranged such that, in any one of the first to fifth aspects of the present invention, the accepting section incorporates, into the attribute information, speaker information that identifies a speaker who uttered the voice; and the determination section determines whether or not the given phrase needs to be presented, in accordance with at least one of the speaker information and another piece of attribute information which is determined by use of the speaker information.

According to the above configuration, in a case where the first voice and the second voice are successively inputted, whether or not a phrase corresponding to each of the first voice and the second voice needs to be presented is determined based on at least speaker information that identifies a speaker of the voice or another attribute information determined by using the speaker information.

This makes it possible to omit an unnatural response depending on a speaker who inputted a voice and therefore achieve a more natural interaction between a user and the information processing device. An interaction typically continues between the same parties. In view of this, it is possible to achieve a more natural interaction by omitting, with use of the speaker information, an unnatural response (e.g., a response to interruption by others) that interrupts a flow of the interaction.

In a seventh aspect of the present invention, the information processing device can be arranged such that, in the sixth aspect of the present invention, the determination section determines that, in a case where speaker information of a voice (speaker information Pc of a target voice) which was inputted earlier than the most recently inputted voice and may be the first voice or the second voice does not match speaker information of the most recently inputted voice (speaker information Pn of the latest voice), a phrase corresponding to the voice inputted earlier than the most recently inputted voice does not need to be presented.

This makes it possible to prioritize an interaction with the latest speech partner and therefore avoid such a problem that responses interrupt each other due to frequent change of speech partners.

In an eighth aspect of the present invention, the information processing device can be arranged such that, in the sixth aspect of the present invention, the determination section determines whether or not the given phrase corresponding to the voice needs to be presented, in accordance with whether or not a relational value associated with the speaker information meets a given condition as a result of being compared with a given threshold, the relational value numerically indicating a relationship between the speaker and the information processing device.

According to the above configuration, in accordance with relationships virtually set between speakers and the information processing device, a response to a voice uttered by any one of the speakers who has a closer relationship with the information processing device is prioritized. This makes it possible to avoid such an unnatural situation where a speaker frequently changes to another speaker due to interruption by the another speaker having a shallow relationship with the information processing device. Examples of the relational value include a degree of intimacy, which indicates intimacy between a user and the information processing device. The degree of intimacy can be determined in accordance with, for example, how frequently the user interacts with the information processing device.

In a ninth aspect of the present invention, the information processing device is arranged such that, in the third to fifth aspects of the present invention, the accepting section further incorporates, into the attribute information, speaker information that identifies a speaker who uttered the voice; the determination section determines that the given phrase does not need to be presented, in a case where a value (required time or degree of newness), calculated by use of the input time or the accepted number, exceeds a given threshold; and the determination section changes the given threshold depending on a relational value associated with the speaker information, the relational value numerically indicating a relationship between the information processing device and the speaker.

This makes it possible to, while prioritizing a response to a speaker having a closer relationship with the interaction processing device, omit a response in a case where the response to a voice is unnatural because the voice was inputted long time ago.

In a tenth aspect of the present invention, the information processing device can be arranged to further include, in any one of the first through ninth aspects of the present invention, a requesting section (phrase requesting section 24) that requests, from an external device, the given phrase corresponding to the voice by transmitting the voice or the recognition result of the voice to the external device; and a receiving section (phrase receiving section 25) that receives, as a response (response 3) to a request (request 2) made by the requesting section, the given phrase that has been transmitted from the external device, and supplies the given phrase to the presentation section.

An information processing system (interactive system 300) of an eleventh aspect of the present invention is an information processing system including: an information processing device (interactive robot 100) that presents a given phrase to a user in response to a voice uttered by the user; and an external device (server 200) that supplies the given phrase corresponding to the voice to the information processing device, the given phrase including a first and a second phrases, the voice including a first and a second voices, the first voice being one that was inputted earlier than the second voice, the information processing device including: a requesting section (phrase requesting section 24) that requests the given phrase, corresponding to the voice, from the external device, by transmitting, to the external device, (i) the voice or a recognition result of the voice and (ii) attribute information indicative of an attribute of the voice; a receiving section (phrase receiving section 25) that receives the given phrase transmitted from the external device as a response (response 3) to a request (request 2) made by the requesting section; and a presentation section (phrase output section 23) that presents the given phrase received by the receiving section, the external device including: an accepting section (phrase request receiving section 60) that accepts the voice which was inputted, by storing, in a storage section (the second voice management table 81 of the storage section 52), (i) the voice or the recognition result of the voice and (ii) the attribute information of the voice in association with each other, the voice, the recognition result, and the attribute information each being transmitted from the information processing device; a transmitting section (phrase transmitting section 62) that transmits, to the information processing device, the given phrase corresponding to the voice accepted by the accepting section; and a determination section (output necessity determination section 63) that, in a case where the second voice is inputted before the transmitting section transmits the first phrase corresponding to the first voice, determines, in accordance with at least one piece of attribute information stored in the storage section, whether or not the first phrase needs to be presented.

According to the configurations of the tenth and eleventh aspect, it is possible to bring about an effect substantially similar to that brought about by the first aspect.

The information processing device in accordance with each aspect of the present invention can be realized by a computer. In this case, the scope of the present invention encompasses: a control program for causing a computer to operate as each section (software element) of the information processing device; and a computer-readable recording medium in which the control program is recorded.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention is applicable to an information processing device and an information processing system each of which presents a given phrase to a user in response to a voice uttered by the user.

### REFERENCE SIGNS LIST

10: Control section
12: Storage section
20: Voice recognition section
21: Input management section (accepting section)
22: Output necessity determination section (determination section)
23: Phrase output section (presentation section)
24: Phrase requesting section (requesting section)
25: Phrase receiving section (receiving section)
50: Control section
52: Storage section
60: Phrase request receiving section (accepting section)
61: Phrase generating section (generating section)
62: Phrase transmitting section (transmitting section)
63: Output necessity determination section (determination section)
100: Interactive robot (information processing device)
200: Server (external device)
300: Interactive system (information processing system)

1. An information processing device that presents a given phrase to a user in response to a voice uttered by the user, the given phrase including a first phrase and a second phrase, the voice including a first voice and a second voice, the first voice being one that was inputted earlier than the second voice,
the information processing device comprising:
a storage section;
an accepting section that accepts the voice which was inputted, by storing, in the storage section, the voice or a recognition result of the voice in association with attribute information indicative of an attribute of the voice;
a presentation section that presents the given phrase corresponding to the voice accepted by the accepting section; and
a determination section that, in a case where the second voice is inputted before the presentation section presents the first phrase corresponding to the first voice, determines, in accordance with at least one piece of attribute information stored in the storage section, whether or not the first phrase needs to be presented.

2. The information processing device as set forth in claim 1, wherein
in a case where the determination section determines that the first phrase needs to be presented, the determination section determines, in accordance with the at least one piece of attribute information stored in the storage section, whether or not the second phrase corresponding to the second voice needs to be presented.

3. The information processing device as set forth in claim 1, wherein:
the accepting section incorporates, into the attribute information, (i) an input time at which the voice was inputted or (ii) an accepted number of the voice; and
the determination section determines whether or not the given phrase needs to be presented, in accordance with at least one of the input time, the accepted number, and another piece of attribute information which is determined by use of the input time or the accepted number.

4. The information processing device as set forth in claim 1, wherein:
the accepting section incorporates, into the attribute information, speaker information that identifies a speaker who uttered the voice; and
the determination section determines whether or not the given phrase needs to be presented, in accordance with at least one of the speaker information and another piece of attribute information which is determined by use of the speaker information.

5. The information processing device as set forth in claim 3, wherein:
the accepting section further incorporates, into the attribute information, speaker information that identifies a speaker who uttered the voice;
the determination section determines that the given phrase does not need to be presented, in a case where a value, calculated by use of the input time or the accepted number, exceeds a given threshold; and
the determination section changes the given threshold depending on a relational value associated with the speaker information, the relational value numerically indicating a relationship between the information processing device and the speaker.
